(19) United States
(12) Patent Application Publication
(10) Pub. No.: US 2015/0316979 A1
(43) Pub. Date: Nov. 5, 2015

(54) SYSTEM AND METHOD FOR BODY-WORN CAMERA WITH RE-CONNECT FEATURE

(71) Applicant: Wolfcom Enterprises, Los Angeles, CA (US)

(72) Inventor: Peter A. Onruang, Los Angeles, CA (US)

(73) Assignee: Wolfcom Enterprises, Los Angeles, CA (US)

(21) Appl. No.: 14/702,596

(22) Filed: May 1, 2015

Related U.S. Application Data
(60) Provisional application No. 61/988,073, filed on May 2, 2014.
(60) Provisional application No. 62/086,654, filed on Dec. 2, 2014.

(51) Int. Cl. G06F 3/01; H04N 5/225; G06F 1/22; H04N 5/77; H04N 5/907; H04N 7/18; G02B 27/01; H04N 5/232

(52) U.S. Cl. CPC G06F 3/011; G02B 27/017; H04N 5/2252; H04N 5/23206; H04N 5/77; H04N 5/907; H04N 5/772; H04N 7/185; G06F 1/22; G02B 2027/014; G02B 2027/0187; G02B 2027/0129; G02B 2027/0138

(57) ABSTRACT

A POV camera system having at least two parts: a main recording unit and an external POV camera having a built-in microphone. The main recording unit also has a built-in camera and microphone. In the event that the external POV camera is disconnected from the main recording unit, the built-in camera and microphone of the main recording unit will activate, and audio and video recording will resume.

### CROSS-REFERENCE TO RELATED APPLICATIONS

The present application claims priority to U.S. Provisional Application No. 61/988,073, entitled “Body Camera with Critical Re-Connect,” filed on May 2, 2014, and U.S. Provisional Application No. 62/086,654, entitled “System and Method for Body-Worn Camera with Re-Connect Feature,” filed on Dec. 2, 2014, the entire contents of which are herein incorporated by reference as if fully set forth herein.

### BACKGROUND OF THE INVENTION

The disclosed technology relates generally to body-worn cameras, and more particularly, some embodiments relate to systems and methods for providing a body-worn camera with a re-connect feature in the event that an external point-of-view camera is disconnected.

Point-of-View (POV) cameras are worn on the head of a user so that audio and video from the camera reflects the user's point-of-view perception. POV cameras normally comprise two parts: a main recording unit and an external POV camera worn on the user's head.

The main recording unit typically contains a battery and a memory for storage, and is worn on the belt or chest area of the user. The external POV camera typically has a built-in microphone, and is connected or plugged into the main recording unit via a cord. When recording is activated, audio and video signals from the external POV camera are sent to the main unit and are recorded into the memory.

In the event that the external POV camera is disconnected from the main recording unit, all audio and video recordings cease, and the POV camera becomes inoperable. Some police officers wear POV cameras and, at times, find themselves in a physical altercation with a suspect. During a struggle or pursuit, the external POV camera can be yanked and disconnected from the main recording unit, resulting in loss of audio and video recording.

### SUMMARY OF THE INVENTION

The present disclosure may be embodied in a camera system comprising a body unit having a body camera; an external camera capable of being connected to the body unit for providing video data to the body unit. The body unit may be configured to detect when the external camera is disconnected, and, if the external camera becomes disconnected, activate the body camera.

In one aspect of this embodiment, the body unit may be configured to detect when the external camera is disconnected by detecting a change in measured voltage. The change in measured voltage may be an increase in the measured voltage. In certain embodiments, the change in measured voltage may be implemented using a GPIO pin in the body unit.

In another aspect, the body unit may be configured to detect when the external camera is disconnected via a mechanical switch.

The present disclosure may also be embodied in a method comprising: detecting an external camera unit connected to a body unit having a body camera; recording video content from the external camera unit; detecting that the external camera unit is disconnected from the body unit; and recording video content from the body camera.

In one aspect of this embodiment, detecting the external camera unit is disconnected from the body unit may comprise detecting a voltage change caused by the disconnecting of the external camera unit from the body unit. The voltage change may be an increase in voltage. The change in measured voltage may be detected using a GPIO pin in the body unit.

In another aspect, detecting the external camera unit is disconnected from the body unit may comprise detecting a change in state by a mechanical switch.

Recording video content from the body camera may occur as a result of detecting that the external camera unit is disconnected from the body unit.

In yet another aspect of this embodiment, recording video content from the external camera unit may comprise storing video data from the external camera unit to a primary memory, and recording video content from the body camera may comprise storing video data from the body camera unit to a secondary memory. Video data may be recorded from the body camera and the external camera unit simultaneously.

The present disclosure may also be embodied in non-transitory computer readable medium comprising an instruction set configured to command a computing device to carry out the methods described herein.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A provides a perspective view of a POV camera system with an external POV camera worn by a user, in accordance with an embodiment of the present disclosure.

FIG. 1B provides a block diagram representation of the POV camera system of FIG. 1A.

FIG. 2 provides a flow chart depiction of a method of implementing a re-connect feature in a POV camera system, in accordance with an embodiment of the present disclosure.

FIG. 3 provides a block diagram of a POV camera system that implements a re-connect feature using a general-purpose input/output (GPIO) pin, in accordance with an embodiment of the present disclosure.

FIG. 4A provides a block-diagram of a POV camera system that implements the re-connect feature using a mechanical switch, in accordance with one embodiment of the present disclosure.

FIGS. 4B and 4C show close-up views of the mechanical switch of FIG. 4A with an external POV camera unplugged and plugged in, respectively.

FIG. 5 provides a block diagram of a POV camera system that implements the re-connect feature through dual-video processing or buffering, in accordance with one embodiment of the technology described herein.

FIG. 6 illustrates a sample computing device that may be used to implement certain features and embodiments of the present disclosure.

### DETAILED DESCRIPTION OF THE INVENTION

The technology disclosed herein is directed toward a system and method for providing a body-worn camera with a re-connect feature in the event that an external point-of-view camera is disconnected.

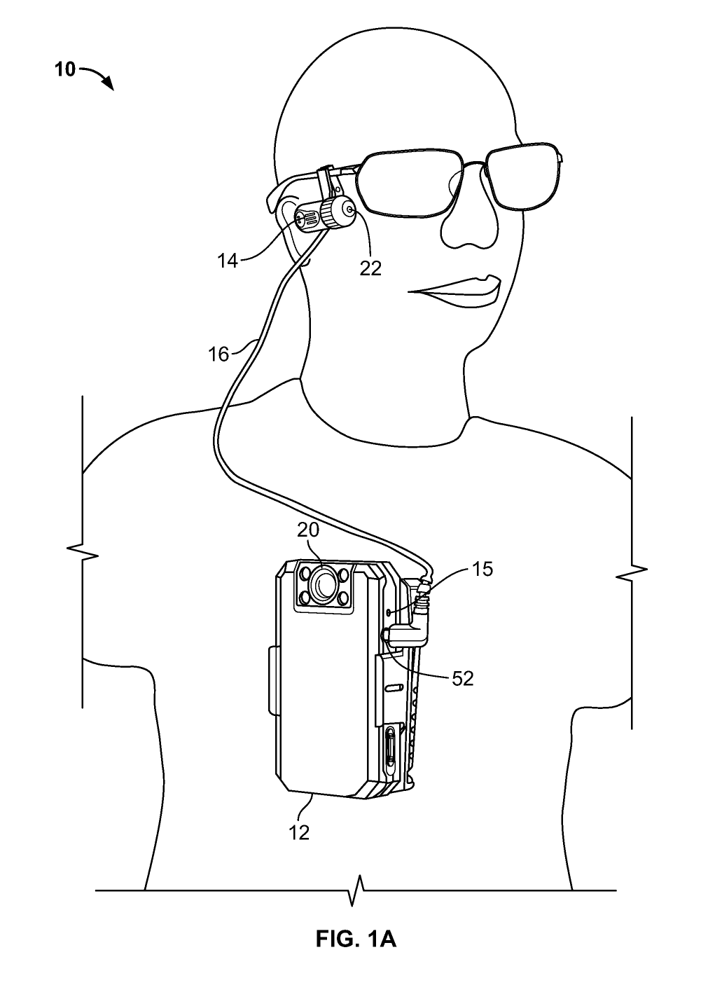

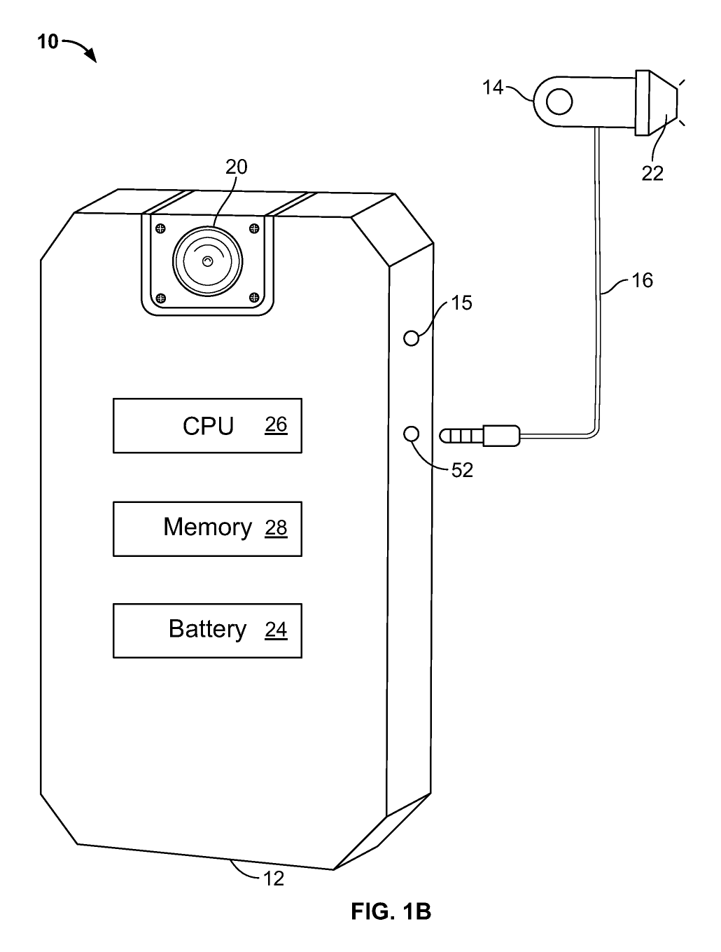

FIG. 1A provides a perspective view of a camera system 10 having a body unit 12 and an external camera unit 14. In the depicted embodiment, the body unit 12 is worn on the user's torso, and the external camera unit 14 is worn on the user's head. The body unit 12 has a body camera 20, and the external camera unit has an external camera 22 for recording audio and video. The external camera unit 14 is connected to the body unit 12 via a cable 16 that is plugged into an external camera slot 52 on the body unit 12. The body unit 12 also has a microphone 15 for recording audio data. It should be understood that the external camera unit 14 also may have a microphone built into it for recording audio data, but it can be understood that the cameras 20, 22 may encompass both audio and video recording capability.

It can be appreciated that, as shown in FIGS. 1A and 1B, it may be preferable in certain applications for the external camera unit 14 to be smaller and lighter in weight than the body unit 12 so that the external camera unit 14 can be worn on an area of the body in which excess weight or size may be cumbersome (e.g., on a user's head). In such embodiments, and as shown in FIG. 1B, it may be the case that a battery 24 is housed in the body unit 12 and the external camera unit 14 is powered by the battery 24 housed in the body unit 12 via the cable 16. Further, memory 28 for storing audio and video recordings from the two cameras 20, 22 may also be housed in the body unit 12, with audio and visual data from the external camera 22 also being transmitted via the cable 16. The body unit 12 may also comprise a processor 26 for processing data.

In certain embodiments, it may be feasible to simply record and store all audio and video input from both the body camera 20 and the external camera 22. However, in other embodiments, it may be more desirable to retain audio/visual data from only one of the two cameras 20, 22. This may be due to data storage considerations, since recording video from both cameras rather than just one will, obviously, double the data storage requirements, which may be expensive. Further, having both cameras activated and recording also reduces battery life. For example, consider the example of a police department that issues body cameras to its officers. Typically, at the end of a shift, officers will turn in their body cameras so that all footage taken during the shift can be pulled from the body camera and stored in long-term memory for later access (e.g., a database or server). Taking feeds from both the main body unit and the external camera will require twice as much storage power, which increases costs to store essentially duplicates of videos.

However, if the recording from only a single camera is stored, then problems may arise if a user is recording from the external camera 22, and then the external camera 22 becomes disconnected. It is a feature of the present disclosure to provide an automatic re-connect feature for substantially continuous video recording by the body unit 12 and the external camera unit 14, even when the external camera unit 14 becomes disconnected.

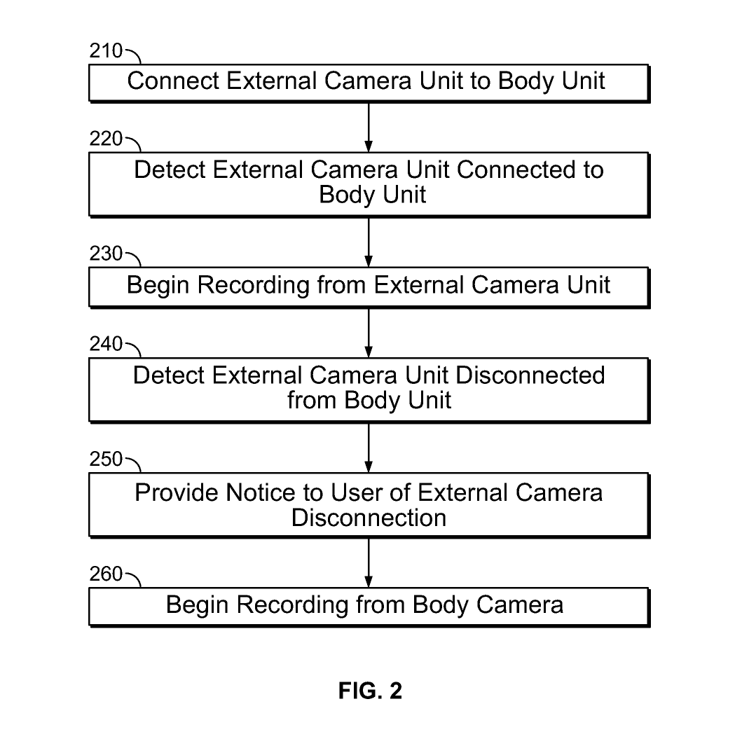

FIG. 2 provides a flow chart representation of one way to implement a re-connect feature in a camera system, in accordance with an embodiment of the present disclosure. In block 210, a user connects the external camera unit 14 to the body unit 12. When the body unit 12 is powered on, the body unit 12 detects that an external camera unit 14 is connected (block 220). Upon detecting that an external camera unit 14 is connected, the body unit 12 begins recording audio and visual data from the external camera 22 (on the external camera unit 14) (block 230). Audio and video data from the external camera 22 is stored in the main memory 28. In certain embodiments, it may be a default setting for the body unit 12 to record from a connected external camera unit 14 if one is detected. Alternatively, the user may select which of the two cameras (body camera 20 or external camera 22) the user wishes to use. In this embodiment, the assumption is made that the body unit 12 is recording from the external camera 22.

Then, at block 240, the external camera unit 14 becomes disconnected and the body unit 12 detects that the external camera unit 14 has become disconnected. At this point, the body unit 12 will provide a notice to the user that the external camera unit 14 has become disconnected (block 250). This may be a visual notification (e.g., flashing lights), an audio notification (e.g., a beeping or a voice recording), a haptic notification (e.g., vibration of the body unit 12), or any combination of the above. The body unit 12 then automatically activates the body camera 20 and begins recording and storing video and audio from the body camera 20 (block 260). By automatically activating the body camera 20 upon detection that the external camera unit 14 has been disconnected, the video feed stored in the body unit 12 is substantially uninterrupted by the lost connection to the external camera unit 14.

The re-connect feature may be implemented in a variety of ways. In one embodiment, the re-connect feature works by electronic detection of a connected or disconnected external camera unit 14. As described above, it will sometimes be the case that the external camera unit 14 is powered by the base unit 12. As such, when the external camera unit 14 is plugged into the base unit 12, the base unit 12 may detect a drop in voltage due to the power drawn by the external camera unit 14. This alerts the base unit 12 that an external camera unit 14 is plugged in. Conversely, if the external camera unit 14 becomes disconnected, the base unit 12 will detect a voltage increase, thus signaling to the base unit 12 that the external camera unit 14 has become disconnected. In alternative embodiments, the opposite may be true, such that a voltage increase signals to the base unit 12 that the external camera unit 14 is connected, and a voltage decrease signals that the external unit camera is disconnected.

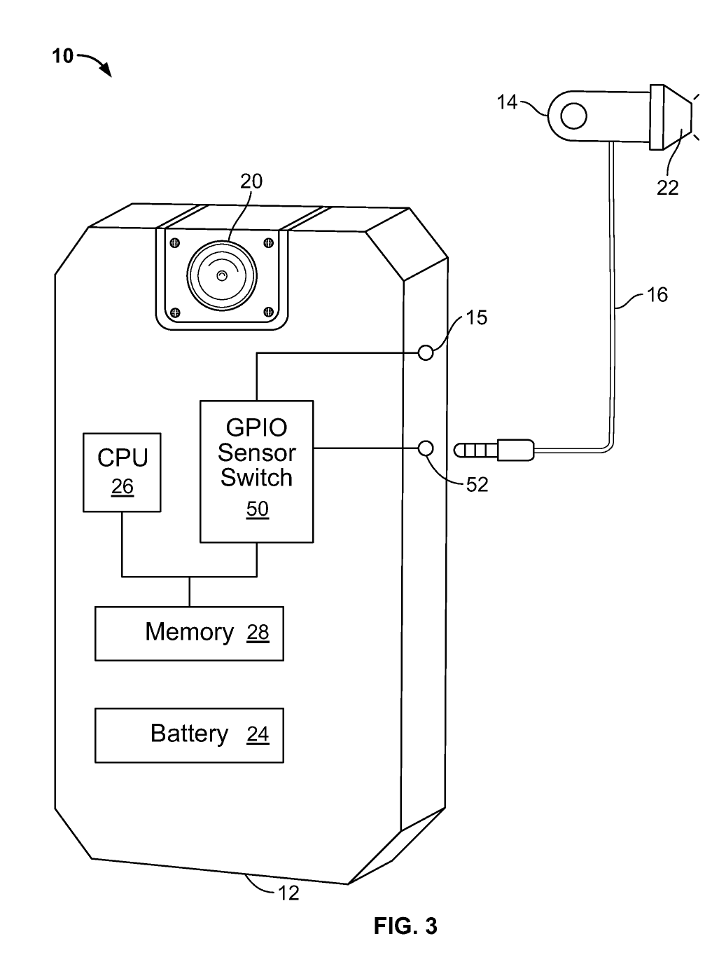

In a particular embodiment, this may be implemented using a general-purpose input/output (GPIO) pin on the chipset of the base unit 12. FIG. 3 provides a block diagram of this embodiment. A GPIO sensor switch 50 is included in the body unit 12. The GPIO sensor switch 50 may be implemented by connecting one end of a NC (normally-closed) contact in the external camera slot 52 of the base unit 12 with a 5V voltage. Another end of the NC contact is connected with a GPIO pin, which serves as an input to the base unit 12's main chipset. When there is no external camera unit plugged into the external camera slot, the 5V voltage is directly applied to the GPIO input pin through the NC contact in the external camera slot 52. Therefore, if the base unit 12's main chipset detects the 5V voltage at the GPIO, it determines that the external camera is not plugged-in. On the other hand, when the external camera unit 14 is plugged into the external camera slot 52, the NC contact is disconnected, and the 5V voltage is not applied to the input of the main chipset. Thus, if the GPIO sensor switch 50 detects a lower voltage at the GPIO pin, it determines that there is an external camera connected.

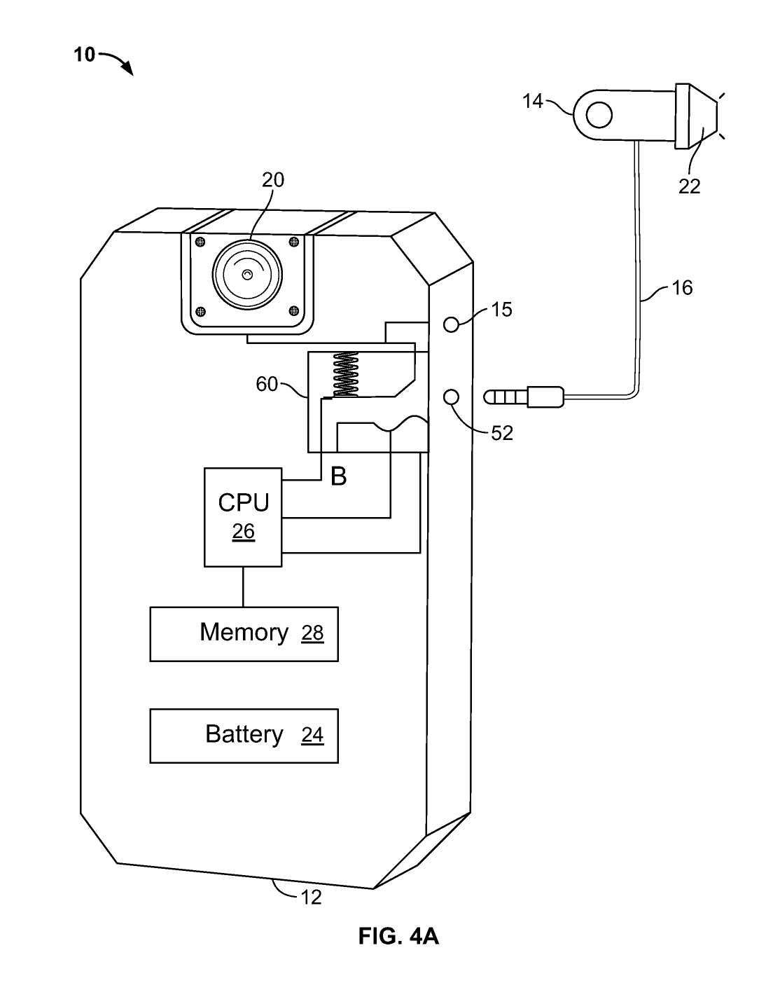

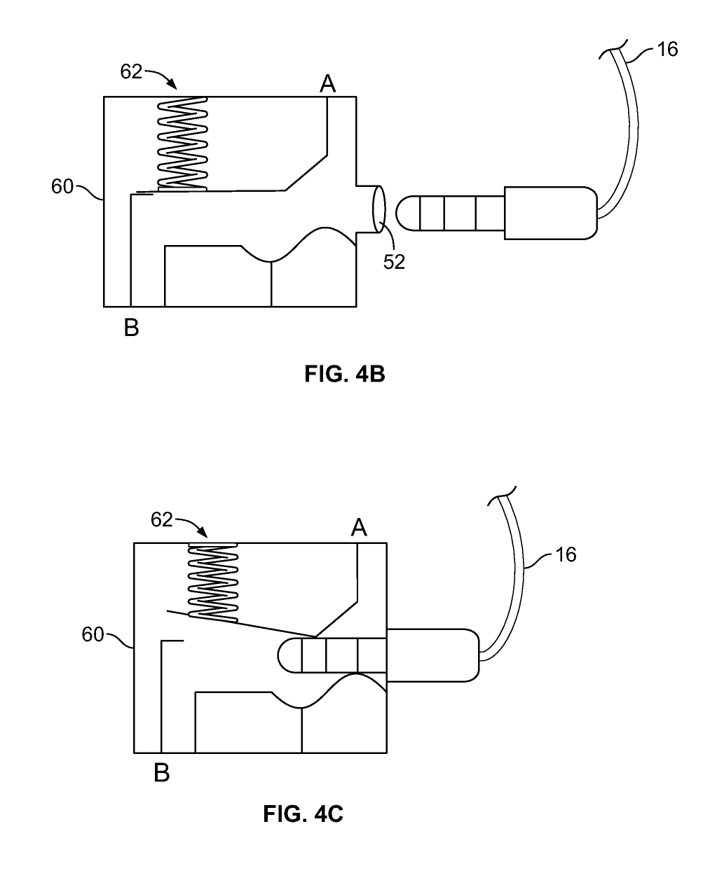

In another embodiment, the re-connect feature can be achieved by using a mechanical switch built into the main recording unit, as shown in FIGS. 4A-C. FIG. 4A shows a block diagram of a camera system 10 that implements the re-connect feature using a mechanical switch 60. When an external camera unit 14 is plugged into or disconnected from the external camera slot 52, this causes the mechanical switch 60 to switch between two states. In a first state in which the external camera unit 14 is unplugged (FIG. 4B) the body camera 20 is activated and recording. In a second state in which the external camera unit 14 is plugged in (FIG. 4C), the body camera 20 is disconnected, and the external camera 22 and its microphone are connected and powered.

FIG. 4B depicts one embodiment of the mechanical switch 60 in a disconnected state, i.e., with the external camera unit 14 disconnected. In FIG. 4B, a spring exerts pressure on the lead connected to point A, and the circuit between point A and point B is closed. In this state, in which the path from point A to point B is closed, the body camera 20 is activated.

Conversely, in FIG. 4C, it can be seen that the external camera unit 14 is plugged in, and mechanically forces open the circuit between point A and point B by applying a force to the spring 62. In FIG. 4C, the male end of the cable 16 from the external camera unit 14 causes the connector A to be pushed up and away from the connector B, severing the connection. If the external camera unit 14 becomes disconnected, then the spring 62 would push the connector A back into contact with the connector B to close the connection. In this way, the mechanical switch 60 can be used to change between two states: a first state indicating that the external camera unit 14 is not connected and the body camera 20 is activated; and a second state indicating that the external camera unit 14 is connected and the body camera 20 should be de-activated and the external camera 22 activated.

It will be understood that the mechanical A/V switch can be oppositely configured so that the connectors A and B are touching when the external camera is plugged in.

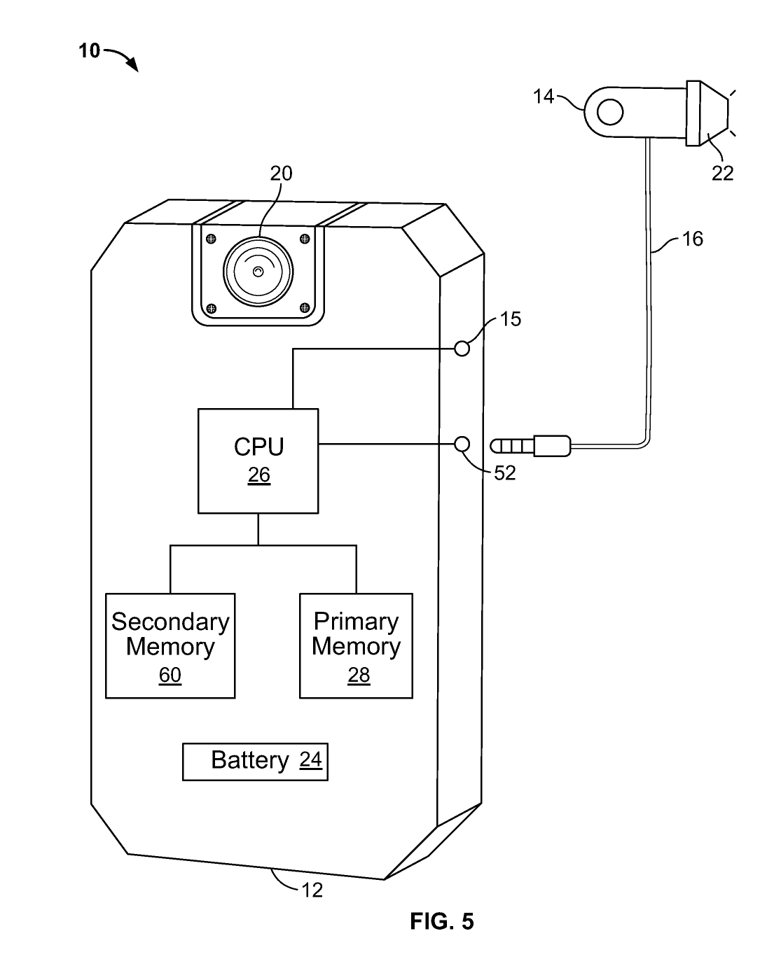

Alternatively, or in conjunction with those embodiments disclosed above, the re-connect feature may also be achieved using a dual-video processing approach. With reference to FIG. 5, there is shown a block diagram of a camera system 10 that implements the re-connect feature through dual-video processing or buffering. In this implementation, the body unit 12 has both a main memory 28 and a secondary memory 60. When the body unit 12 is used as a standalone unit without the external camera unit 14 unplugged, video recorded from the body camera 20 is stored in the primary memory 28. However, when an external camera unit 14 is plugged into the body unit 12, audio and video from the external camera 22 is recorded and stored in the primary memory 28, while audio and video from the body camera 20 is now stored in a secondary memory 60. If, the external camera unit 14 becomes disconnected, then data from the external camera 22 will be lost, but the body camera 20 will continue to save its recording data to the secondary memory 60, such that any video that is lost due to the disconnection of external camera 22 can be replaced using video from the body camera 20 that is stored in the secondary memory 60. Alternatively, the body unit 12 may detect that the external camera 22 has become disconnected, and begin storing the video feed from the body camera 20 to the primary memory 28 or to both the primary memory 28 and the secondary memory 60.

It should be understood that while the figures have presented exemplary embodiments of the present systems and methods, revisions may be made to the disclosed systems and methods without departing from the scope of the present disclosure.

Where components or modules of the disclosed systems and methods are implemented in whole or in part using software, in one embodiment, these software elements can be implemented to operate with a computing or processing module capable of carrying out the functionality described with respect thereto. After reading this description, it will become apparent to a person skilled in the relevant art how to implement the disclosure using other computing modules or architectures.

As used herein, the term module might describe a given unit of functionality that can be performed in accordance with one or more implementations. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

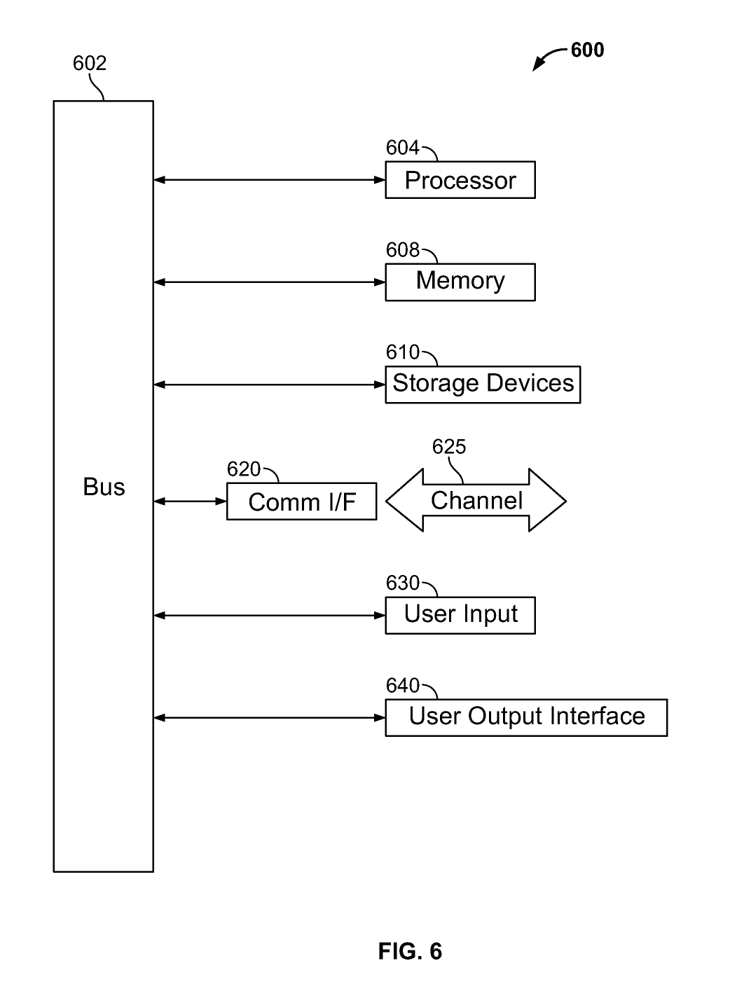

Referring now to FIG. 6, computing module 600 may represent, for example, computing or processing capabilities found within the body camera 12 or the external camera unit 14; or any other type of special-purpose or general-purpose computing devices as may be appropriate. Computing module 600 might also represent computing capabilities embedded within or otherwise available to a given electronic device that might include some form of processing capability.

Computing module 600 might include, for example, one or more processors, controllers, control modules, or other processing devices, such as a processor 604. Processor 604 might be implemented using a general-purpose or special-purpose processing engine such as, for example, a microprocessor, controller, or other control logic. In the illustrated example, processor 604 is connected to a bus 602, although any communication medium can be used to facilitate interaction with other components of computing module 600 or to communicate externally.

Computing module 600 might also include one or more memory modules, simply referred to herein as main memory 608. For example, random access memory (RAM) or other dynamic memory might be used for storing information and instructions to be executed by processor 604. Main memory 608 might also be used for storing temporary variables or other intermediate information during execution of instructions to be executed by processor 604. Computing module 600 might likewise include a read only memory (“ROM”) or other static storage device coupled to bus 602 for storing static information and instructions for processor 604. The computing module 600 might also include one or more various storage devices 610, which might include, for example, a magnetic tape drive, an optical disc drive, a solid state drive, removable storage media such as a CD or DVD, or any other non-volatile memory.

Computing module 600 might also include a communications interface 620. Communications interface 620 might be used to allow software and data to be transferred between computing module 600 and external devices. Examples of communications interface 620 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 620 might typically be carried on signals, which can be electronic, electromagnetic (which includes optical) or other signals capable of being exchanged by a given communications interface 620. These signals might be provided to communications interface 620 via a channel 625. This channel 625 might carry signals and might be implemented using a wired or wireless communication medium. Some examples of a channel might include a phone line, a cellular link, an RF link, an optical link, a network interface, a local or wide area network, and other wired or wireless communications channels.

Computing module 600 might also include one or more user inputs 630. The user input allows for the user to enter commands to the computing module 600 and interact with it. Examples of user inputs might include a computer mouse, a keyboard, a touch-sensitive screen, a stylus, a mousepad, a joystick, an accelerometer, a gyroscope, a camera, a remote control, control buttons or knobs, or any other user input mechanism.

The computer module 600 might also include one or more user output interfaces 640. The user output interfaces 640 might be used to interact with the user by presenting information or sensory outputs for the user. Examples of user output interfaces might include visual outputs, such as a display screen or monitor, audio outputs, such as a speaker or headphone output, or haptic outputs such as a vibrating motor.

In this document, the terms “computer readable medium” and “computer usable medium” are used to generally refer to media such as, for example, memory 608, storage unit 610, and channel 625. These and other various forms of computer readable media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present disclosure as discussed herein.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features. Additionally, with regard to flow diagrams, operational descriptions and method claims, the order in which the steps are presented herein shall not mandate that various embodiments be implemented to perform the recited functionality in the same order unless the context dictates otherwise. Thus, the breadth and scope of the present disclosure should not be limited by any of the exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Although the invention has been described in detail with reference only to the presently preferred embodiments, those skilled in the art will appreciate that various modifications can be made without departing from the claimed invention.

1. A camera system comprising:
a body unit having a body camera; and
an external camera capable of being connected to the body unit for providing video data to the body unit, wherein
the body unit is configured to
detect when the external camera is disconnected, and
if the external camera becomes disconnected, activate the body camera.

2. The camera system of claim 1, wherein the body unit is configured to detect when the external camera is disconnected by detecting a change in measured voltage.

3. The camera system of claim 2, wherein the change in measured voltage is an increase in the measured voltage.

4. The camera system of claim 2, wherein the change in measured voltage is implemented using a GPIO pin in the body unit.

5. The camera system of claim 1, wherein the body unit is configured to detect when the external camera is disconnected via a mechanical switch.

6. A method comprising:
detecting an external camera unit connected to a body unit having a body camera;
recording video content from the external camera unit;
detecting that the external camera unit is disconnected from the body unit; and
recording video content from the body camera.

7. The method of claim 6, wherein detecting the external camera unit is disconnected from the body unit comprises detecting a voltage change caused by the disconnecting of the external camera unit from the body unit.

8. The method of claim 7, wherein the voltage change is an increase in voltage.

9. The method of claim 7, wherein detecting a voltage change may comprise using a GPIO pin in the body unit to detect the voltage change.

10. The method of claim 6, wherein detecting the external camera unit is disconnected from the body unit comprises detecting a change in state by a mechanical switch.

11. The method of claim 6, wherein recording video content from the body camera occurs as a result of detecting that the external camera unit is disconnected from the body unit.

12. The method of claim 6, wherein:
recording video content from the external camera unit comprises storing video data from the external camera unit to a primary memory, and
recording video content from the body camera comprises storing video data from the body camera unit to a secondary memory.

13. The method of claim 12, wherein video content is recorded from the body camera and the external camera unit simultaneously.

14. A non-transitory computer readable medium comprising an instruction set configured to cause a computing device to perform:
detecting an external camera unit connected to a body unit having a body camera;
recording video content from the external camera unit;
detecting that the external camera unit is disconnected from the body unit; and
recording video content from the body camera.

15. The non-transitory computer-readable medium of claim 14, wherein detecting the external camera unit is disconnected from the body unit comprises detecting a voltage change caused by the disconnecting of the external camera unit from the body unit.

16. The non-transitory computer-readable medium of claim 15, wherein the voltage change is an increase in voltage.

17. The non-transitory computer-readable medium of claim 14, wherein detecting the external camera unit is disconnected from the body unit comprises detecting a change in state by a mechanical switch.

18. The non-transitory computer-readable medium of claim 14, wherein recording video content from the body camera occurs as a result of detecting that the external camera unit is disconnected from the body unit.

19. The non-transitory computer-readable medium of claim 14, wherein:
recording video content from the external camera unit comprises storing video data from the external camera unit to a primary memory, and
recording video content from the body camera comprises storing video data from the body camera unit to a secondary memory.

20. The non-transitory computer-readable medium of claim 19, wherein video content is recorded from the body camera and the external camera unit simultaneously.
